(19) United States
(12) Patent Application Publication
(10) Pub. No.: US 2004/0202195 A1
(43) Pub. Date: Oct. 14, 2004

(54) Communication systems

(76) Inventors: Andrew Bateman, Bath (GB); Mehdi Nouri, Essex (GB)

Correspondence Address: FLEIT KAIN GIBBONS GUTMAN & BONGINI, COURVOISIER CENTRE II, SUITE 404, 601 BRICKELL KEY DRIVE, MIAMI, FL, 33131, US

(21) Appl. No.: 10/746,947

(22) Filed: Dec. 24, 2003

Related U.S. Application Data
(63) Continuation of application No. PCT/GB02/03048, filed on Jul. 1, 2002.

(30) Foreign Application Priority Data
Jun. 29, 2001 (GB) 0116020.9

(51) Int. Cl. H04J 15/00

(52) U.S. Cl. 370/464

(57) ABSTRACT

A communication system having at least one transmitter and at least one receiver is arranged to communicate with one another over a communications channel so as to transmit information from the transmitter to the receiver. The communications channel consists of two or more carriers. The transmitter is arranged to divide information to be transmitted on channels into packets of information and to transmit different packets of information on at least two carriers. Thereby, the information transfer rate of the channel is increased. Each carrier can include sub-carriers so as to further increase the information transfer rate. Furthermore, each carrier can have more than time slot and the transmitter can select any combination available of carriers or time slots of a carrier to aid high speed information transfer.

### RELATED APPLICATION

This application is a continuation of International Application PCT/GB02/03048, filed Jul. 1, 2002, the contents of which are here incorporated by reference in their entirety.

### BACKGROUND OF THE INVENTION

1. Field of the Invention

The present invention relates to a communication system and a method of operating a communication system, and relates in particularly, but not exclusively, to a communications system for operation in accordance with the European TETRA (TErrestrial Trunked Radio) suite of standards as promulgated from time to time by ETSI (European Telecommunications Standards Institute).

2. Prior Art

There is now a desire to improve the first generation of the TETRA standard so as to provide enhanced data transmission services. One proposal to fulfil the requirement for TETRA High Speed Data, known as TAPS (TETRA Advanced Packet Service) has been approved by ETSI to be used along side the first generation of TETRA systems. This standard has all the advantages of a GSM (Global System for Mobile) or GPRS (General Packet Radio System) since it is very much based on the principles of GSM or GPRS and uses a broad band of frequency spectrum in order to convey data to be transmitted at high speed. That is, TAPS provides access to 815 kb/s (thousand bits per second) of raw data. Furthermore, TAPS has the advantage of having a very large source of mobile terminal manufacturers and suppliers. However, in order to utilise TAPS one needs access to a new wide band of frequency spectrum and a TAPS system is in effect an overlay or additional system to a conventional TETRA system and it has little compatibility with the first generation of TETRA systems. Therefore, ETSI has requested that an alternative standard for TETRA High Speed Data be investigated so as to provide a second generation of the TETRA standard which is an enhancement of the first generation of the TETRA standard and which has a very high level of compatibility with the first generation of TETRA. Thus such a system will overcome the disadvantages associated with TAPS. This form of the standard, if eventually approved by ETSI, will be known as TEDS (TETRA Enhanced Data Service).

### SUMMARY OF THE INVENTION

The invention described herein forms part of the applicants proposal to ETSI for such a TEDS standard.

It is known to provide a communication system which comprises at least one transmitter and at least one receiver arranged to communicate with one another over a communications channel so as to transmit information from the transmitter to the receiver, the communications channel comprising at least two carriers. Furthermore, a method of operating a communication system, including arranging at least one transmitter and at least one receiver to communicate with one another over a communications channel such that information is transmitted from the transmitter to the receiver and arranging the communications channel to comprise at least two carriers is also known.

It is an object of the present invention to obviate or mitigate the disadvantages associated with the prior art.

According to a first aspect of the present invention the communication system is characterised in that the transmitter is arranged to divide information to be transmitted on the communications channel into packets of information and to transmit different packets of information on at least two carriers.

In this manner, information to be transmitted can be divided into smaller more manageable parts or packets and different packets can be conveyed on different carriers, each carrier being arranged to occupy a normal radio frequency carrier spacing of a first generation TETRA system. Accordingly, different carriers can be used to transmit the information more quickly over the communications channel whilst still conforming to the requirement of the carrier spacing arrangement specified in the first generation of the TETRA standard. Thus the applicants proposal for TEDS is rendered compatible with the existing first generation of the TETRA standard in respect of carrier spacing arrangements.

The term “information” used throughout this document is intend to include both “voice” and “data” communications, whether separately or a combination of the both.

Furthermore, different packets of information may be transmitted on adjacent carriers. Alternatively, at least two different packets of information may be transmitted on non-adjacent carriers. In this manner, the information to be transmitted over the communications channel need not be transmitted on adjacent or contiguous channels thereby adding greater flexibility to the communication system as it may be built around carriers that have been pre-arranged for or are currently utilized for a different purpose and allow frequency planners or channel controllers to make the most affective use of the spectrum of carriers available at the time of transmission of the information over the communications channel. Preferably, different packets of information may be transmitted on different carriers at substantially the same time.

The transmitter may be arranged to determine whether the different packets of information should be transmitted substantially in parallel on different carriers or sequentially on two or more different carriers based on the type of information to be transmitted. That is, if the information to be transmitted is voice then fewer carriers (most likely one carrier) may be used relative to the number of carriers required to transmit data type information. Each carrier may comprise more than one time slot, and the base radio station and remote radio unit may be able to transmit information on any of the carriers and any of the time slots within the carriers. In this manner, a channel controller can determine on which different carriers and which slot or slots, within each carrier, information should be transmitted. For example, in a TETRA system which uses four time slots per carrier, the system controller could send information on any of the four time slots in combination with any of the carriers.

Preferably, each carrier may be contained within a 25 kHz radio frequency carrier signal spacing. In this manner, each carrier will occupy the 25 kHz allocated to a normal spacing of a first generation TETRA system. Furthermore, each carrier may be divided into two substantially equal sub-carriers. Each sub-carrier may be 12.5 kHz and the pair of sub-carriers may be contained within a 25 kHz radio frequency carrier signal spacing. Each carrier may comprise a Quadrature Amplitude Modulated carrier signal or Differential Eight Phase Shift Keying carrier signal.

According to another aspect of this invention the method of operating a communication system is characterised by arranging the transmitter to divide information to be transmitted on the communications channel into packets of information and transmitting different packets of information on at least two carriers.

Preferably, the method may include transmitting different packets of information on adjacent carriers or alternatively transmitting at least two different packets of information on non-adjacent carriers. Also the method may include transmitting the packets of information on different carriers at substantially the same time. Furthermore, the method may include arranging the transmitter to determine whether the different packets of information should be transmitted substantially in parallel on different carriers or sequentially on two or more different carriers based on the type of information to be transmitted. The method may include arranging each carrier to comprise more than one time slot and arranging the base radio station and remote radio unit to transmit information on any of the carriers and any of the time slots within the carriers.

According to a further aspect of the invention a TETRA communication system comprises at least one remote mobile radio unit including a receiver and at least one base radio station having a transmitter arranged to communicate with the receiver of each remote mobile radio unit substantially as described in the communication system above.

According to another aspect of the invention a method of operating a TETRA communication system includes having at least one remote mobile radio unit including a receiver and at least one base radio station having a transmitter arranged to communicate with the receiver of each remote mobile radio unit substantially as described in the method of operating a communication system above.

According to another aspect of the invention, a TETRA communication system comprises at least one remote mobile radio unit including a transceiver and at least one base radio station having a transceiver arranged to communicate with the transceiver of the remote mobile radio unit, the transceiver of the base radio station being arranged to broadcast messages to the transceiver of the remote radio unit to indicate the status of information to be transmitted between the transceiver of the remote mobile radio unit and the transceiver of the base radio station over a communications channel between the remote mobile radio unit and the base radio station, characterised in that the broadcast messages include a link usage element to specify the transmitter and receiver capabilities of the base radio station transceiver.

Preferably, the link usage element contains an indication of the modulation technique to be utilized between the transceiver of the base radio unit and the transceiver of the remote radio unit over the communications channel.

According to a further aspect of the present invention, a TETRA communication system comprises at least one remote mobile radio unit including a transceiver and at least one base radio station having a transceiver arranged to communicate with the transceiver of the remote mobile radio unit, the transceiver of the remote radio unit being arranged to broadcast messages to the transceiver of the base radio station to indicate the status of information to be transmitted between the transceiver of the remote mobile radio unit and the transceiver of the base radio station over a communications channel between the remote mobile radio unit and the base radio station, characterised in that the broadcast messages include a link usage element to specify the transmitter and receiver capabilities of the remote radio unit transceiver.

Preferably, the link usage element contains an indication of the modulation technique to be utilized between the transceiver of the base radio unit and the transceiver of the remote radio unit over the communications channel.

According to another aspect of the invention, a communications system comprises a first set of remote radio units arranged to communicate with a base radio station over a communications channel comprising a plurality of carriers, the first set of remote radio units and the base radio station being arranged to utilize at least one carrier to transmit information between the first set of remote radio units and the base radio station, characterised in that a second set of remote radio units are also arranged to communicate over the communications channel with the base radio station by dividing information to be transmitted on the communications channel into packets of information and to transmit different packets of information on at least two different carriers and wherein a channel controller is arranged to determine each carrier that is being used by the first set of remote radio units and the base radio station and to assign the least two carriers for use by the second set of remote radio units and the base radio station from the remaining carriers not used by the first set of remote radio units and the base radio station.

In this manner, the channel controller can make better use of the carriers by, if necessary, assigning non-adjacent for use by the second set of remote radio units and base radio station should carriers be used by the first set of remote radio units and the base radio station in such a way as to prevent assigning adjacent carriers for use by the second set of remote radio units and base radio station. It will be understood that some of the first set of remote radio units may also belong to the second set of remote radio units but at the time when the channel controller determines each carrier that is being used by the first set of remote radio units and the base radio station those remote radio units which are in both the first and second set are at that time communicating with the base radio station in the first set mode and so are classed as remote radio units in the first set until they cease communication with the base radio station in the first set mode.

### BRIEF DESCRIPTION OF THE DRAWINGS

The invention will now be described, by way of example only, with reference to the accompanying drawings, in which:

FIG. 1 illustrates a schematic diagram of a communications system according to the present invention;

FIG. 2 illustrates an arrangement of the sub-carriers in accordance with the present invention;

FIG. 3 illustrates a slot arrangement and use of non-adjacent carriers to transfer information in accordance with the present invention; and

FIGS. 4a and 4b illustrate the burst structure for a downlink and an uplink burst respectively.

### DETAILED DESCRIPTION OF PREFERRED EMBODIMENTS OF THE INVENTION

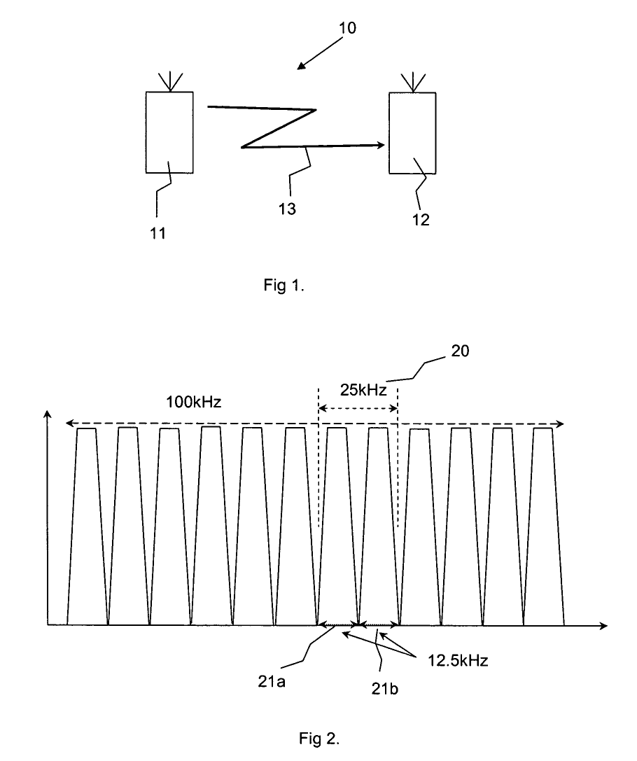

Referring to FIG. 1, a TETRA communications system 10 comprises at least one base radio station 11 having a transceiver arranged to communicate with a remote radio unit 12 over a communications channel 13 between the base radio station 11 and the remote radio unit 12. A TETRA first generation communications channel comprises a number of carriers arranged in 25 kHz intervals so that information to be transmitted over the communications channel can be assigned to one of the carriers.

Referring to FIG. 2, given the discrete channelisation or slot arrangement of the first generation of TETRA, ranging from single 25 kHz carriers 20 and 25 kHz multiples, up to 150 kHz, there is insufficient bandwidth to permit resolution of multi-path echoes in the transmission path. It should be noted that in FIG. 2 frequency is indicate along the abscissa axis and amplitude indicated along the ordinate axis. This rules out the use of wideband spread spectrum techniques such as those used in UMTS/3G cellular systems, which employ efficient Rake receiver technology to resolve the combined multi-path echo energy. Such Rake receiver technology require 5 MHz of channel bandwidth to be effective. It is thus necessary to ensure that the channel time delay is a small fraction of the symbol period for negligible channel induced ISI (Inter Symbol Interference), and to avoid the need for complex, power hungry adaptive equalization techniques. Systems such as GSM Edge, which operate at 200 kHz radio frequency channel bandwidth, do not satisfy this criterion as multi-path echoes correspond to a significant portion of the symbol period.

With typical first generation TETRA delay spread values in the order of 10 μs (micro-seconds), a symbol period greater than 100 μs is desirable. This translates into a symbol rate of about 10 k symbols per second. On a band pass TETRA channel, this would result in an occupied bandwidth in the order of 12.5 kHz for a practical pulse shaping factor. This system analysis suggests that a 12.5 kHz raster per modulated carrier will be a multi-path tolerant solution. Since a 12.5 kHz raster is half the rate of a first generation TETRA system using a 25 kHz raster arrangement it will marry well with the first generation TETRA carrier raster. Therefore, the basis of the modulation format for TEDS is a two sub-carrier approach each sub-carrier 21a or 21b having a bandwidth of 12.5 kHz so as both sub-carrier fit within the same frequency spacing of 25 kHz carrier 20 arrangement for a first generation TETRA system.

Therefore, to maintain compatibility with a first generation TETRA system, the overall symbol rate in a 25 kHz channel will be 18 k symbols per second, organised on two sub-carriers 21a, 21b, each with 9 k symbols per second.

For optimum performance, Trellis Coded Modulation (TCM) with M-ary QAM (M-Array Quadrature Amplitude Modulation) can be used. This technique combines modulation and coding to achieve significant coding gains without compromising bandwidth efficiency. The TCM expands the signal set to provide redundancy for coding. This enables coding and signal mapping design functions which jointly maximise the free distance between the coded signals. In the receiver, signals are decoded by a soft decision maximum likelihood sequence decoder. Furthermore, either pilot tone or pilot symbols can be included to assist with channel estimation to enable coherent detection at the receiver.

The principle reasons for adopting a M-ary QAM scheme are: It provides two to two and a half times the data rate of the current first generation TETRA system in a 25 kHz channel (28.8 k bits per second for a four slot user data rate on conventional TETRA system can be increased to around 57 k bits per second using TCM 32 QAM and 72 k bits per second using TCM 64 QAM);

The symbol rate is chosen to maintain the basic 25 kHz carrier spacing, thereby maintaining compatibility with conventional TETRA systems; and TCM and coherent detection provide improved sensitivity to maximise range with a potential 5 dB gain in Eb/No (Energy per Bit/Noise power spectral density).

It will be understood that in a first generation TETRA system, each carrier is arranged to carry four time slots which each containing system information and/or voice/data information to be transmitted over the communications channel.

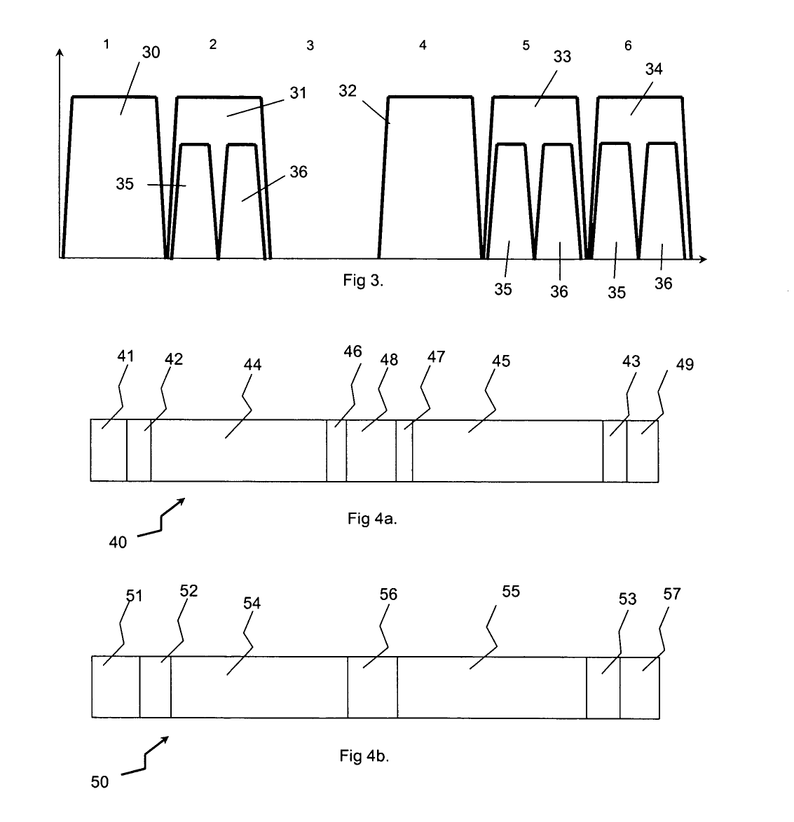

Referring to FIG. 3, information can be sent on a single carrier 30 to 34 at different speeds using a suitable form of modulation, for example Differential Eight Phase Shift Keying (D8PSK) or M-ary QAM, and also by using one or more of the four slots on one or more carriers at once. It should be noted that in FIG. 3 frequency is indicate along the abscissa axis and amplitude indicated along the ordinate axis. With an appropriate transmitter the modulation can be changed on a slot by slot basis. For example, information in the form of a packet message containing four slots worth of data information can be sent serially on one carrier having a four slot arrangement or alternatively can be sent in one timeslot on four different carriers or any combination of carriers and time slots. Time slots are allocated on a flexible basis by a channel controller within the base station so that voice calls can be sent simultaneously with data calls.

FIG. 3 shows an example of the frequency spectrum that might be transmitted from a base radio station at a particular instant in time. In this example, first generation TETRA voice calls are in operation on carriers 1 and 4 indicated by references 30 and 32, using conventional π/4DQPSK (pi/4 Phase Offset Differential Quadrature Phase Shift Keying), carrier 2 indicated by reference 31, is a data call using D8PSK, carrier 3 is not currently being used and carriers 5 and 6 indicated by references 33 and 34, are both being used for high speed data to the same remote radio unit. It should be noted that the channel controller could if desired use carriers 2, 5 and 6 indicated by references 31, 33 and 34, to transmit a message to the same remote radio unit thereby making more use of the available carriers and adapting the communication pathway between the base radio station and the mobile radio unit around other communication pathways in use between the base radio station and other mobile radio units, for example on carriers 1 and 4 indicated by references 30 and 32. It will be noted that carriers 2, 5 and 6 indicated by references 31, 33 and 34, all use two sub-carriers 35 and 36 to transmit information.

Combining separate base radio station transmitters with contiguous carriers is possible for up to approximately four carriers with hybrid combiners or by using separate antennas without excessiveg loss of power. In this way additional carriers can be added to an existing system and these can be placed adjacent to one of the existing carriers or all carriers on the site can be moved into a contiguous block of carriers. For more than four carriers, power losses become excessive and the space taken up by the hardware will become an issue. However, it is likely that the additional new transmitters will be able to transmit π/4DQPSK and D8PSK and existing transmitters may be able to be upgraded to the same specification.

The alternative is to generate all the carriers together in a digital signal processor (DSP) or combine them all at low levels and amplify them all together as a composite signal for transmission. The peak to average power ratio (PAPR) of the combined signal is then of interest as it affects the size, cost and power consumption of the transmitter. The PAPR of a single carrier using π/4DQPSK is about 3.5 dB and the peak to mean ratio for a single channel coded QAM is approximately 6 dB. This is the price to pay for higher data capacity with good Eb/No performance. The summation of two carriers produces a theoretical peak to mean power ration which is 3 dB higher, however controlled clipping in the signal processing can reduce this to about 7.8 dB. With more than three channels, a 10 dB peak to mean power ratio is required. The option exists to reduce the peak to mean excursions by clipping the output of the composite multi-carrier waveform, removing the largest and most infrequent signal peaks. The effect of such clipping is to introduce both in-band and out-of-band distortion. The former having the potential to degrade performance of the modems of the transceivers used to transmit and receive the signals transmitted, the latter potentially causing interference to users in adjacent bands. Using appropriate post clipping filters and DSP corrections the overall multi-carrier peak to mean ratio can be reduced to around 7 dB. Further reductions are possible depending on the level of complexity employed.

It will be understood that if an existing TETRA system has limited spare capacity and faster packet data capabilities are needed it is possible to add further carriers to the system. These carriers can be dedicated solely to high speed data use but it is much more beneficial if this extra resource can be used for both voice and data operation. The extra capacity can then be deployed under the system control of a channel controller as the levels of voice and data traffic vary. It is then possible for high speed data to be spread over more than one carrier and sent in parallel, depending on the capability of the equipment used in the system, the speed requirements and the existing traffic. In addition the carriers of the system can also use different modulation methods on a slot by slot basis to further enhance the data capability. Such modulations methods could be D8PSK or M-ary QAM for example 32 or 64 QAM.

Radio frequency carriers on an existing TETRA site will usually be deployed with considerable frequency spacing between them. To use a number of these carriers to simultaneously transmit data from the packet message at higher speed requires either separate receivers for each carrier or a relatively complex wide band system. The receiver is considerably simplified if some or all of the carriers can be placed within a small defined block of carriers up to about 150 kHz (i.e. six carriers) and when necessary on adjacent channels. This block of 25 kHz channels can then be received together in a wide band receiver in the same way as a block of Coded Orthogonal Frequency Division Multiplexing (COFDM). To allow the most flexible use of this set of carriers, they must be able to be used separately as in as normal TETRA voice and data (TETRA V+D) first generation system or together to allow data to be sent at higher speeds.

The multi-carrier approach gives flexibility of placement of the carriers within the confines of the carrier block (up to six carriers) based on the mobile radio unit transceiver bandwidth. All the carriers can be used or some left out. Due to the uniformity of the framing structure and the timeslot duration they can be used in a flexible manner on a slot by slot basis to support conventional (first generation) TETRA V+D calls and high speed data. Furthermore, the modulation type on the up and downlink do not have to be the same.

This proposal defines a practical and rapidly deliverable upgrade path from relatively low data rate of the first generation of TETRA, i.e. 36 kb/s, to data rates that support the ultimate market requirements of video and image transfer. The highest data rates are limited only by the need to deliver robust and reliable communication that does not require significant network expansion and investment in new equipment and frequency spectrum.

For example, Table 1 below gives an indication of the data rates achievable using different form of modulation techniques within the 25 kHz slot arrangement of a first generation TETRA system.

TABLE 1
Raw Data Throughput for Defined Types of Modulation

| | Radio Frequency Bandwidth |
|---|---|
| Symbol Depth | 25 kHz |
| M = 4; (π/4DQPSK) | 36 kbps |
| M = 8; (D8PSK) | 54 kbps |
| TCM M = 32 QAM | 72 kbps |
| TCM M = 64 QAM | 90 kbps |

In order to achieve the highest possible data transfer on a carrier, a form of M-ary type modulation should be employed. The current π/4DQPSK first generation of TETRA solution uses m=4 modulation with 2 bits per symbol. For higher data rates it is necessary to increase M to carry more bits per second. The applicant's proposal for TEDS supports two classes of M-ary modulation, one based on DPSK (Differential Phase Shift Keying) and the other on QAM. Both of these can be used in single or multi-carrier TEDS systems with 25 kHz carrier spacing.

The DPSK modulation class includes π/4DQPSK and D8PSK with two and three bits per symbol respectively. The QAM modulation class includes TCM 32 QAM and TCM 64 QAM supporting four and five bits respectively. The techniques employed in the case of D8PSK are chosen to provide a low complexity, fast-to-market enhancement and those selected for QAM have been chosen to provide an enhancement highly optimised for performance. D8PSK, TCM 32 QAM and TCM 64 QAM respectively give one and a half fold, two fold and two and a half fold increases in throughput of data over the current TETRA technology of π/4DQPSK as can be observed from Table 1.

Accordingly, when each of these types of M-ary modulation are used in conjunction with a multi-carrier TEDS system as proposed by the applicant the data rates ranges as indicated in Table 2 can be achieved.

TABLE 2
Approximate Data Rates for TEDS System (kbit/s)

| | 1 Carrier | | 2 Carrier | | 3 Carrier | | 4 Carrier | | 5 Carrier | | 6 Carrier | |
|---|---|---|---|---|---|---|---|---|---|---|---|---|
| | 25 kHz | | 50 kHz | | 75 kHz | | 100 kHz | | 125 Khz | | 150 kHz | |
| | Number of Slots Used to Transmit Information | | | | | | | | | | | |
| Modulation | 1 | 4 | 1 | 4 | 1 | 4 | 1 | 4 | 1 | 4 | 1 | 4 |
| π/4 unprotected | 7.2 | 28.8 | 14.4 | 57.6 | 21.6 | 86.4 | 28.8 | 115.2 | 36 | 144 | 43.2 | 172.8 |
| π/4 protected | 4.5 | 17.9 | 8.9 | 35.7 | 13.4 | 53.6 | 17.9 | 71.5 | 22.3 | 89.3 | 26.8 | 107.2 |
| D8PSK | 11.5 | 46 | 23 | 92 | 34.5 | 138 | 46 | 184 | 57.5 | 230 | 69 | 276 |
| unprotected | | | | | | | | | | | | |
| D8PSK protected | 7.3 | 29.2 | 14.7 | 58.7 | 22 | 88 | 29.3 | 117.3 | 36.7 | 146.7 | 44 | 176 |
| Trellis coded 32 | 14.4 | 57.6 | 28.8 | 115.2 | 43.2 | 172.8 | 57.6 | 230.4 | 72 | 288 | 86.2 | 346 |
| QAM unprotected | | | | | | | | | | | | |
| Trellis coded 32 | 9.6 | 38.4 | 19.2 | 76.8 | 28.8 | 115.2 | 38.4 | 153.6 | 48 | 192 | 57.5 | 230 |
| QAM protected | | | | | | | | | | | | |
| Trellis coded 64 | 18 | 72 | 36 | 144 | 54 | 216 | 72 | 288 | 90 | 360 | 108 | 432 |
| QAM unprotected | | | | | | | | | | | | |
| Trellis coded 64 | 12 | 48 | 24 | 96 | 36 | 14 | 48 | 192 | 60 | 240 | 72 | 288 |
| QAM protected | | | | | | | | | | | | |

Notes for Table 2:

One slot is the minimum allocation on each carrier and four slots is the maximum; and

The precise figures for data rates depends on the exact slot structure.

Referring to FIGS. 4a and 4b, the base radio station and the remote radio unit each communicate their system status information and information (voice and/or data) to one another using information transmitted in up-link and down-link bursts or time slots. In FIG. 4a, a down-link slot 40 is indicated which comprises 255 symbols, equating to 765 bits of information in a 14.2 millisecond burst. This is the information transmitted from the base radio station to the remote radio unit. The slot 40 comprises ramp and linearisation information (9 bits) indicated by reference 41, two areas of phase information (3 bits each) indicated by references 42 and 43, two areas of scrambled information (345 bits each) indicated by references 44 and 45, two areas of broadcast information (15 bits each) indicated by references 46 and 47, training sequence information (21 bits) indicated by reference 48 and finally ramp down information (9 bits) indicated by reference 49. It should be noted that training sequence information 48 may not be required for all forms of system status information bursts transmitted on the down-link.

In FIG. 4b, an up-link slot 50 is indicated which comprises 255 symbols, equating to 765 bits of information in a 14.2 millisecond burst. This is the information transmitted from the remote radio unit to the base radio station. The slot 50 comprises ramp and linearisation information (24 bits) indicated by reference 51, two areas of phase information (3 bits each) indicated by references 52 and 53, two areas of scrambled information (345 bits each) indicated by references 54 and 55, training sequence information (21 bits) indicated by reference 56 and finally ramp down information (24 bits) indicated by reference 57.

The base radio station broadcasts over its coverage area that it is capable of transmitting or receiving high speed information in TEDS format and, if so, the modulation technique used in the scrambled information sections 44 and 45 of the down-link slot 40 using the reserved bit during a D-MLE-SYSINFO PDU (Down-link System Information Packet Data Unit) carried by the MAC's SYSINFO PDU (Medium Access Control System Information Packet Data Unit) for confirming TEDS supported and some of the reserved bits from the “extended services broadcast” information element of the MAC's SYSINFO PDU of a first generation TETRA system to confirm the modulation technique used. That is the base radio station broadcasts it ability to use TEDS and if so, the modulation technique used to all remote radio units within transmission range. In this way, remote radio units within range of the base radio station with TEDS capability can respond to the broadcast message with a confirmation of TEDS capability and the modulation techniques supported by the remote radio unit using the scrambled information sections 54 and 55 of an up-link slot 50 during registration with the base radio station in the U-LOCATION UPDATE PDU (Up-link Location Update Packet Data Unit). Furthermore, the remote radio unit may also indicate the number of carriers it can simultaneously receive or transmit.

Once the base radio station has established that a remote radio unit can use TEDS then the base radio station and its channel controller can allocate resource appropriate to the demand for transmission of information over the communications channel. That is, the carriers and slot or slots to be used to transmit information and the different type of modulation to be used in each different slot.

Should a remote radio unit not support TEDS then it will not be able to read the reserved bits broadcast by TEDS compatible base radio stations and will not be able to response to such broadcast information. In this case the TEDS compatible base radio station will assume that the lack of appropriate response indicates a lack of TEDS compatible and will treat the remote radio unit as a first generation TETRA terminal.

What is claimed is:

1. A communication system, comprising at least one transmitter and at least one receiver arranged to communicate with one another over a communications channel so as to transmit information from the transmitter to the receiver, the communications channel comprising at least two carriers, characterised in that the transmitter is arranged to divide information to be transmitted on the communications channel into packets of information and to transmit different packets of information on at least two carriers.

2. A communication system, as claimed in claim 1, characterised in that different packets of information are transmitted on adjacent carriers.

3. A communication system, as claimed in claim 1, characterised in that at least two different packets of information are transmitted on non-adjacent carriers.

4. A communication system, as claimed in claim 1, characterised in that the different packets of information are transmitted on different carriers at substantially the same time.

5. A communication system, as claimed in claim 1, characterised in that the transmitter is arranged to determine whether the different packets of information should be transmitted substantially in parallel on different carriers or sequentially on two or more different carriers based on the type of information to be transmitted.

6. A communication system, as claimed in claim 1, characterised in that each carrier is contained within a 25 kHz radio frequency carrier signal spacing.

7. A communication system, as claimed in claim 1, characterised in that each carrier is divided into two substantially equal sub-carriers.

8. A communication system, as claimed in claim 7, characterised in that each sub-carrier is 12.5 kHz and the pair of sub-carriers are contained within a 25 kHz radio frequency carrier signal spacing.

9. A communication system, as claimed in claim 1, wherein each carrier comprises more than one time slot, characterised in that the base radio station and remote radio unit can transmit information on any of the carriers and any of the time slots within the carriers.

10. A communication system, as claimed in claim 1, characterised in that each carrier comprises a Quadrature Amplitude Modulated carrier signal or Differential Eight Phase Shift Keying carrier signal.

11. A method of operating a communication system, including arranging at least one transmitter and at least one receiver to communicate with one another over a communications channel such that information is transmitted from the transmitter to the receiver and arranging the communications channel to comprise at least two carriers, characterised by arranging the transmitter to divide information to be transmitted on the communications channel into packets of information and transmitting different packets of information on at least two carriers.

12. A method of operating a communication system, as claimed in claim 11, characterised by transmitting different packets of information on adjacent carriers.

14. A method of operating a communication system, as claimed in claim 11, characterised by transmitting different packets of information on non-adjacent carriers.

15. A method of operating a communication system, as claimed in claim 11, characterised by transmitting different packets of information on different carriers at substantially the same time.

16. A method of operating a communication system as claimed in claim 11, characterised by arranging the transmitter to determine whether the different packets of information should be transmitted substantially in parallel on different carriers or sequentially on two or more different carriers based on the type of information to be transmitted.

17. A method of operating a communication system, as claimed in claim 11, including arranging each carrier to comprise more than one time slot, characterised by arranging the base radio station and remote radio unit to transmit information on any of the carriers and any of the time slots within the carriers.

18. A TETRA communication system, comprising at least one remote mobile radio unit including a receiver and at least one base radio station having a transmitter arranged to communicate with the receiver of each remote mobile radio unit substantially as claimed in claim 1.

19. A method of operating a TETRA communication system having at least one remote mobile radio unit including a receiver and at least one base radio station having a transmitter arranged to communicate with the receiver of each remote mobile radio unit substantially as claimed in claim 11.

20. A TETRA communication system, comprising at least one remote mobile radio unit including a transceiver and at least one base radio station having a transceiver arranged to communicate with the transceiver of the remote mobile radio unit, the transceiver of the base radio station being arranged to broadcast messages to the transceiver of the remote radio unit to indicate the status of information to be transmitted between the transceiver of the remote mobile radio unit and the transceiver of the base radio station over a communications channel between the remote mobile radio unit and the base radio station, characterised in that the broadcast messages include a link usage element to specify the transmitter and receiver capabilities of the base radio station transceiver.

21. A TETRA communication system, comprising at least one remote mobile radio unit including a transceiver and at least one base radio station having a transceiver arranged to communicate with the transceiver of the remote mobile radio unit, the transceiver of the remote radio unit being arranged to broadcast messages to the transceiver of the base radio station to indicate the status of information to be transmitted between the transceiver of the remote mobile radio unit and the transceiver of the base radio station over a communications channel between the remote mobile radio unit and the base radio station, characterised in that the broadcast messages include a link usage element to specify the transmitter and receiver capabilities of the remote radio unit transceiver.

22. A TETRA communication, as claimed in claim 21, characterised in that the link usage element contains an indication of the modulation technique to be utilized between the transceiver of the base radio unit and the transceiver of the remote radio unit over the communications channel.

23. A communication system, comprising a first set of remote radio units arranged to communicate with a base radio station over a communications channel comprising a plurality of carriers, the first set of remote radio units and the base radio station being arranged to utilize at least one carrier to transmit information between the first set of remote radio units and the base radio station, characterised in that a second set of remote radio units are also arranged to communicate over the communications channel with the base radio station by dividing information to be transmitted on the communications channel into packets of information and to transmit different packets of information on at least two different carriers and wherein a channel controller is arranged to determine each carrier that is being used by the first set of remote radio units and the base radio station and to assign the least two carriers for use by the second set of remote radio units and the base radio station from the remaining carriers not used by the first set of remote radio units and the base radio station.
